(19) United States
(12) Patent Application Publication
(10) Pub. No.: US 2026/0066559 A1
(43) Pub. Date: Mar. 5, 2026

(54) ELECTRICAL CONNECTOR WITH IMPROVED TERMINALS

(71) Applicants: FOXCONN (KUNSHAN) COMPUTER CONNEC TOR CO., LTD., Kunshan (CN); FOXCONN INTERCONNECT TECHNOLOGY LIMITED, Grand Cayman (KY)

(72) Inventor: SHUO-HSIU HSU, Phoenix, AZ (US)

(21) Appl. No.: 18/824,851

(22) Filed: Sep. 4, 2024

(51) Int. Cl. H01R 12/71; H01R 13/24; H01R 13/41; H01R 13/50

(52) U.S. Cl. CPC H01R 12/714; H01R 13/24; H01R 13/41; H01R 13/50

(57) ABSTRACT

An electrical connector includes: an insulating housing defining an upper face and a lower face; and two terminals retained in the insulating housing, each of the two terminals comprising an upper elastic arm extending out of the upper face and a lower elastic arm extending out of the lower face, each of the upper elastic arm and the lower elastic arm comprising an arc mating portion, wherein a first distance is defined between the upper elastic arms of the two terminals, a second distance is defined between the lower elastic arms of the two terminals, and the first distance is larger than the second distance.

### BACKGROUND OF THE INVENTION

### 1. Field of the Invention

The present invention relates to an electrical connector for connecting with a chip module.

### 2. Description of Related Arts

U.S. Pat. No. 11,349,244 B2 discloses an electrical connector loaded with a plurality of metallic contacts for electrically connecting with a CPU module. The metallic contact includes a retention section and an extension section transversely linked with each other via a bridge. An upper contacting arm and a lower contacting arm extend from opposite ends of the retention section and an upper abutment tab and a lower abutment tab extend from opposite ends of the extension section. The upper contacting arms press against corresponding upper abutment tabs and the lower contacting arms press against corresponding lower abutment tabs when the CPU module is inserted into the electrical connector, thereby establishing dual electric paths for each metallic contact. Mechanical performance of LGA/LGA contact can be highly affected by contact pitch. This metallic contact is a LGA/LGA contact and of a single piece. Correspondingly, plural terminal passages defined on an insulating housing to receive and support corresponding contacts, need to be large enough for the lower contacting arm to go through during assembling. This electrical connector is not well designed for optimized mechanical performance. Furthermore, rotation phenomenon can be seen very often in reality when the upper and lower contacting arms are not actuated at the same time. Therefore, an improved electrical connector is desired to overcome the disadvantages of the related art.

### SUMMARY OF THE INVENTION

An object of the present invention is to provide an electrical connector with improved terminals.

In order to achieve above-mentioned object, an electrical connector comprises: an insulating housing defining an upper face and a lower face; and a plurality of terminals retained in the insulating housing, wherein each of the plurality of terminals is composed of an upper piece and a lower piece distinct from each other, each of the upper and lower pieces comprises a retaining portion retained in the insulating housing, an elastic arm having an arc mating portion and a touching portion, and a supporting portion; the elastic arms of the upper pieces extend out of the upper face and the supporting portions of the upper pieces extend out of the lower face, the elastic arms of the lower pieces extend out of the lower face and the supporting portions of the lower pieces extend out of the upper face; after the elastic arms of the upper and the lower pieces are moved toward the insulating housing, the touching portions of the upper pieces press against the supporting portions of corresponding lower pieces and the touching portions of the lower pieces press against the supporting portions of corresponding upper pieces.

Other objects, advantages and novel features of the present invention will become more apparent from the following detailed description of the present embodiment when taken in conjunction with the accompanying drawings.

### BRIEF DESCRIPTION OF THE DRAWING

FIG. 1 is a perspective view of an electrical connector of this present invention;

FIG. 2 is an exploded perspective view of the electrical connector in FIG. 1;

FIG. 3 is a perspective view of one terminal;

FIG. 4 is a top plane view of the electrical connector in FIG. 1;

FIG. 5 is a front plane view of the terminal in FIG. 1;

FIG. 6 is a cross-sectional view of the electrical connector taken along line A-A in FIG. 1, wherein the pressed terminal is sketched in broken line;

FIG. 7 is a cross-sectional view of the electrical connector taken along line B-B in FIG. 1; and

FIG. 8 is another embodiment of this present invention, wherein the two terminals are located between a chip module and a printed circuit board sketched in broken line.

### DETAILED DESCRIPTION OF THE PREFERRED EMBODIMENTS

Reference will now be made in detail to the preferred embodiments of the present invention.

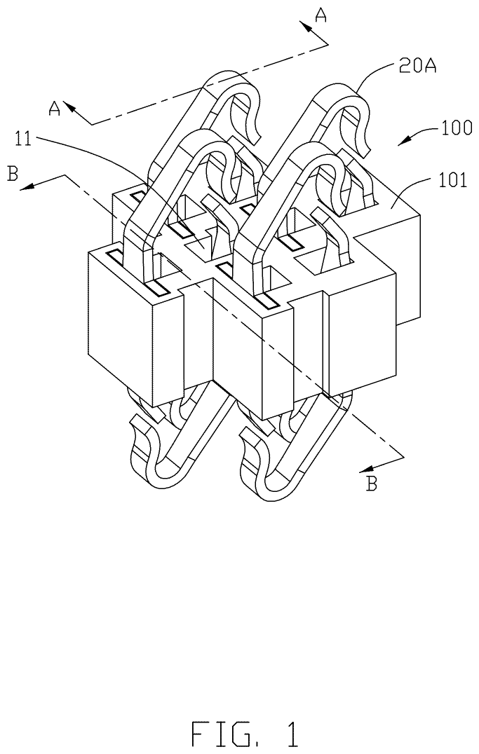

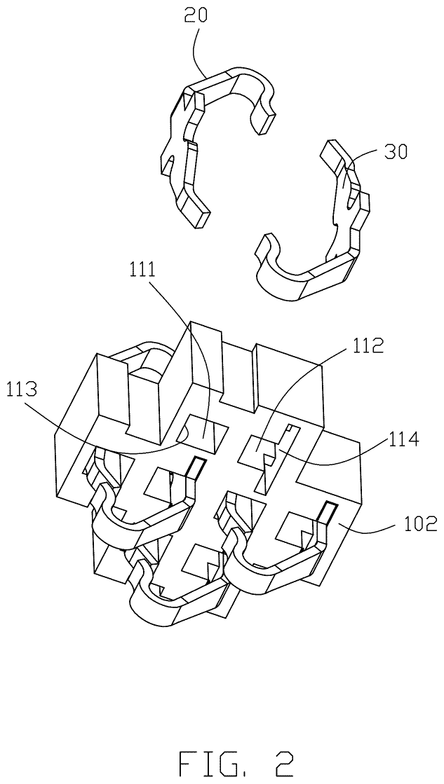

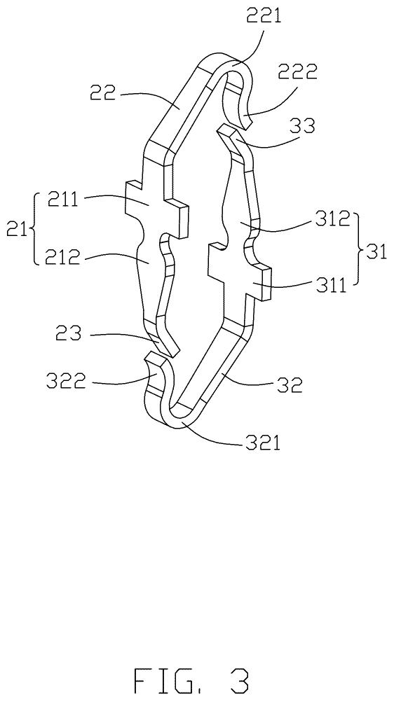

Referring to FIGS. 1-7, an electrical connector 100 of an embodiment of this present invention is illustrated to get an electrical connection between a chip module and a printed circuit board. The electrical connector 100 includes an insulating housing 10 defining an upper face 101 and a lower face 102 and a plurality of terminals 20A retained in insulating housing. Only part of the insulating housing 10 and some conductive terminals 20A are shown in figures. The insulating housing 10 has a plurality of passages 11 through the upper face and the lower face to receive and retain the terminals 20A.

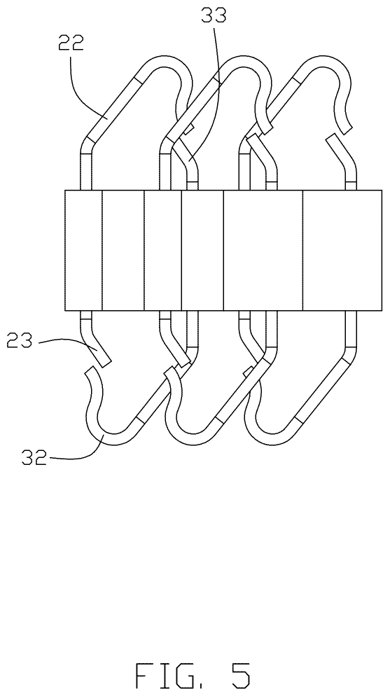

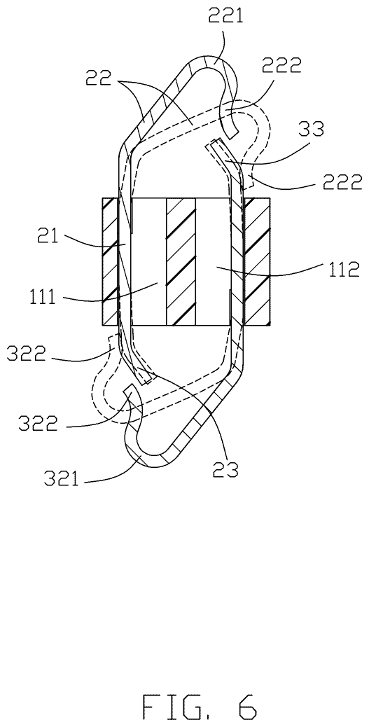

Referring to FIGS. 1-3, each of the plurality of terminals 20A is composed of an upper piece 20 and a lower piece 30 distinct from each other. The upper and lower pieces are separately retained in corresponding passages 11 For clear distinction, the passages to retain the upper pieces 20 are named as first passages 111 and the passages to retain the lower pieces 30 are named as second passages 112. In this embodiment, the upper piece 20 and the lower piece 30 are same in structure. Each of the upper and lower pieces comprises a retaining portion 21, 31 retained in the insulating housing 10, an elastic arm 22, 32, and a supporting portion 23, 33 extending from opposite ends of the retaining portion. The elastic arm has an arc mating portion 221, 321 and a touching portion 222, 322. As clearly shown in FIG. 5, the elastic arms 22 of the upper pieces 20 extend out of the upper face 101 and the supporting portions 23 of the upper pieces extend out of the lower face 102; the elastic arms 32 of the lower pieces extend out of the lower face 102 and the supporting portions 33 of the lower pieces extend out of the upper face 101. As clearly shown in FIG. 6, after the mating portions 221, 321 are moved toward the insulating housing 10, the touching portions 222 of the upper pieces press against the supporting portions 33 of corresponding lower pieces and the touching portions 322 of the lower pieces press against the supporting portions 23 of corresponding upper pieces to get a mechanical and electrical connection between the two pieces. Therefore, a dual-electrical-path of each of those LGA/LGA terminals is obtained.

The mating portions 221, 321 are of an inverted U shape opening toward the upper face or the lower face, the touching portions 222, 322 extend from corresponding mating portions. The supporting portion 23, 33 bends from the retaining portion 21, 31 and slants towards corresponding elastic arm 32, 22 so as to be located below corresponding touching portions. The retaining portions of the upper piece and the lower piece are located in a face to face state.

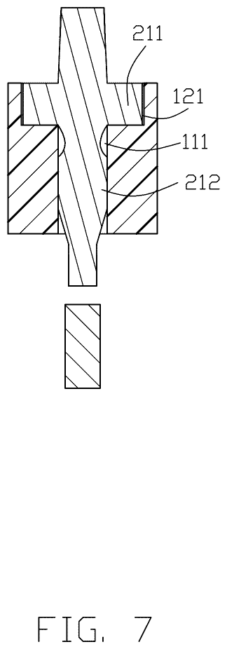

The retaining portions 21 of the upper pieces 20 are retained in the first passages 111, the retaining portions 31 of the lower pieces 30 are retained in the second passages 112. The supporting portions 23 go cross the first passages 111 from the upper face 101 until the retaining portions 21 are retained in the first passages 111, the supporting portions 33 go cross the second passages 112 from the lower face 102 until the retaining portions 31 are retained in the second passage 112. Each of the first passage and second passage has a far-most inside 113, 114 from each other, the far-most insides of the first and second passages are parallel to each other, the retaining portions 21, 31 are retained along the far-most insides of the first and second passages respectively. The retaining portion of each of the upper and lower piece comprises a transverse bar 211, 311 and an upright bar 311, 312, the insulating housing 10 defines a first recess 121 at the upper face 101 and a second recess 122 at the lower face, the first recess 121 is located at the far-most inside 113, the second recess 122 is located at the far-most inside 114. As clearly shown in FIG. 7, the transverse bars 211 of the upper pieces are stopped in the first recesses 121 and the upright bars 212 are retained in the first passages 111. Similarly, the transverse bars 311 of the lower pieces 30 are stopped in the second recesses 122 and the upright bars 312 are retained in the second passages 112. The upright bars 212, 312 are interfered with far-most insides of the passages, respectively. In this embodiment, the passages 11 are rectangular in an upright direction.

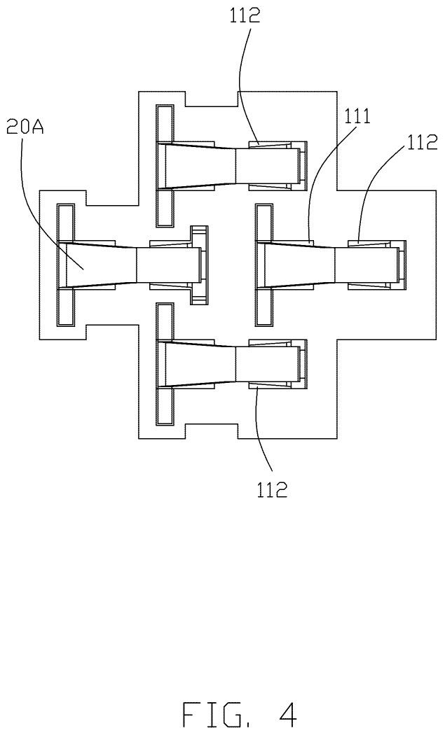

As shown in FIG. 4, the terminals 20A are arranged in a matrix pattern, each terminal 20A extend in a first direction or the left-right direction in drawing, multiple terminals are lined in a row in the first direction. Adjacent rows of the terminals are offset in a second direction perpendicular to the first direction. The first passages 111 and the second passages 112 of each row are arranged alternatively one by one. That is, the first passages 111 and the second passages 112 are arranged in a matric patter, in each row or column the first passages and the second passages alternate one by one.

Referring to FIGS. 5-6, the elastic arms 22 of the upper pieces extend above corresponding second passages 112, the elastic arms 32 of the lower pieces extend above corresponding first passages 111. The supporting portions 23, 33 do not extend beyond corresponding arc mating portions 221, 321 in the first direction. Understandingly, in this embodiment, each terminal 20A is composed of two same metal pieces, one metal piece is inserted from the upper face and another is inserted from the lower face, which not only the manufacture method is simplified but also the two metal pieces are close to each other. The two elastic arms of each terminal can be actuated more independently than a single-piece contact. Moreover, the elastic arms of each terminal can be design longer than the single-piece contact. No need to have passages bigger in size than the elastic arm to go through during assembly process, thereby benefitting to mechanical performance.

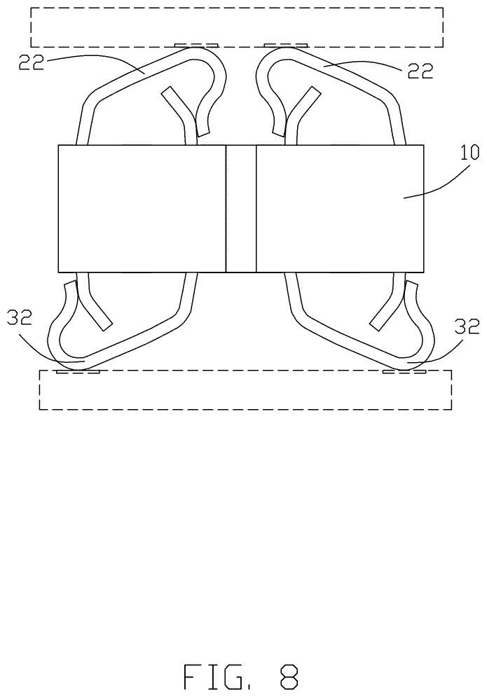

Moreover, the two-piece terminals can be used in other terminal pattern as shown in FIG. 8. In FIG. 8, the upper elastic arms 22 of the upper pieces are located more near to each other of two adjacent terminals 20A, two elastic arms 32 of the lower pieces are located more far from each other of two adjacent terminals 20A, which provide more space on the PCB for routing. That is, the upper elastic arms and the lower elastic arms are offset in the first direction. As clearly shown, a first distance is disposed between the upper elastic arms 22 of the two terminals, a second distance is disposed between the lower elastic arms 32 of the two terminals, the first distance is larger than the second distance.

However, the disclosure is illustrative only, changes may be made in detail, especially in matter of shape, size, and arrangement of parts within the principles of the invention.

1. An electrical connector comprising:
an insulating housing defining an upper face and a lower face; and
a plurality of terminals retained in the insulating housing;
wherein each of the plurality of terminals is composed of an upper piece and a lower piece distinct from each other, each of the upper and lower pieces comprises a retaining portion retained in the insulating housing, an elastic arm having an arc mating portion and a touching portion, and a supporting portion; the elastic arms of the upper pieces extend out of the upper face and the supporting portions of the upper pieces extend out of the lower face, the elastic arms of the lower pieces extend out of the lower face and the supporting portions of the lower pieces extend out of the upper face; after the elastic arms of the upper and the lower pieces are moved toward the insulating housing, the touching portions of the upper pieces press against the supporting portions of corresponding lower pieces and the touching portions of the lower pieces press against the supporting portions of corresponding upper pieces.

2. The electrical connector as claimed in claim 1, wherein the mating portion is of an inverted U shape opening toward the upper face or the lower face, and the touching portion extends from the mating portion.

3. The electrical connector as claimed in claim 2, wherein the supporting portion bends from the retaining portion and slants towards corresponding elastic arm so as to be located below corresponding touching portion.

4. The electrical connector as claimed in claim 1, wherein the retaining portions of the upper piece and the lower piece are located in a face to face state.

5. The electrical connector as claimed in claim 1, wherein the insulating housing defines plural first passages and plural second passages distinct from each other and arranged alternately one by one, the retaining portions of the upper pieces are retained in the first passages, and the retaining portions of the lower pieces are retained in the second passages.

6. The electrical connector as claimed in claim 5, wherein each of the first passage and the second passage has a far-most inside from each other, the far-most inside of the first and second passages are parallel to each other, and the retaining portions are retained in the far-most insides of the first and second passages respectively.

7. The electrical connector as claimed in claim 6, wherein the retaining portion of each of the upper and lower pieces comprises a transverse bar and an upright bar, the insulating housing defines a first recess at the upper face and a second recess at the lower face, the transverse bars of the upper pieces are stopped in the first recesses and the upright bars are retained in the first passages, and the transverse bars of the lower pieces are stopped in the second recesses and the upright bars are retained in the second passages.

8. The electrical connector as claimed in claim 7, wherein the first passages and the second passages are arranged in a matrix pattern, the first passages and the second passages alternate one by one in each row or column.

9. The electrical connector as claimed in claim 5, wherein the elastic arms of the upper pieces extend above corresponding second passages and the elastic arms of the lower pieces extend above corresponding first passages.

10. The electrical connector as claimed in claim 5, wherein the supporting portions of the upper pieces go through corresponding first passages and the supporting portions of the lower pieces go through corresponding second passages.

11. An electrical connector comprising:
an insulating housing defining an upper face and a lower face and a row of passages arranged in a first direction and each running through the upper and lower face, the row of passages being divided into first passages and second passages alternating one by one; and
a plurality of metal pieces each comprising a retaining portion and an elastic arm and a supporting portion extending from opposite ends of the retaining portion, the elastic arm having an arc mating portion and a touch portion;
wherein the supporting portions of half of the metal pieces go cross the first passages from the upper face until the retaining portions are retained in the first passages, the supporting portions of the other half of the metal pieces go cross the second passages from the lower face until the retaining portions are retained in the second passages, and every two adjacent metal pieces are mechanically and electrically connected with each other to form a conductive terminal.

12. The electrical connector as claimed in claim 11, wherein the insulating housing has plural first recesses at the upper face and plural second recesses at the lower face, the retaining portion of each metal piece defines a transverse bar, and the transverse bars are blocked in corresponding first recesses or second recesses.

13. The electrical connector as claimed in claim 12, wherein the retaining portion of each of the metal pieces comprises an upright bar extending from a corresponding transverse bar, the upright bars are interference fit with insides of the first or second passages.

14. The electrical connector as claimed in claim 11, wherein the passages are rectangular as viewed from the upper face, the retaining portion of each of half of the metal pieces is retained in a first inside of the first passage, the retaining portion of each of the other half of the metal pieces is retained in a second inside of the second passage, and the second inside of the second passage is far-most from the first inside of the first passage.

15. An electrical connector comprising:
an insulating housing defining an upper face and a lower face; and
two terminals retained in the insulating housing, each of the two terminals comprising an upper elastic arm extending out of the upper face and a lower elastic arm extending out of the lower face, each of the upper elastic arm and the lower elastic arm comprising an arc mating portion;
wherein a first distance is defined between the upper elastic arms of the two terminals, a second distance is defined between the lower elastic arms of the two terminals, and the first distance is larger than the second distance.
